(19) United States
(12) Patent Application Publication
(10) Pub. No.: US 2016/0096393 A1
(43) Pub. Date: Apr. 7, 2016

(54) SECURITY MARK WITH CHROMA-BASED ENCODING

(71) Applicant: Xerox Corporation, Norwalk, CT (US)

(72) Inventors: Edward N. Chapman, Rochester, NY (US); Reiner Eschbach, Webster, NY (US)

(21) Appl. No.: 14/507,975

(22) Filed: Oct. 7, 2014

(51) Int. Cl. B42D 25/30; H04N 1/32

(52) U.S. Cl. CPC B42D 25/30; H04N 1/32203; H04N 1/32309

(57) ABSTRACT

A secure document contains a security mark that includes a background that exhibits a first color, and a foreground that exhibits a second color. The first color and the second color together exhibit a chrominance variation that is not visible to the unaided human eye or when viewed with the assistance of a magnifying glass, but that is visible when viewed with the assistance of a microscope. A method and system for printing such a document are also disclosed.

### BACKGROUND

Security is an important requirement in many document printing applications. In situations such as official or government document printing, event ticket printing, financial instrument printing and the like, many printed documents must be protected against copying, forging and/or counterfeiting.

For these reasons, many documents have security marks, such as those that are visible only in the presence of infrared light, in the presence of ultraviolet light, under a specialized microscope, or with the use of a decoding “key” device. However, security marks that require additional hardware to decode are not always desirable, as the hardware is not always readily available in all use cases. For example, specialized infrared microscopes are not commonly available at government office, event venues or other locations where document verification will be performed. Additionally, people often prefer security elements that cannot simply be identified as such. For example, MicroText marks are easily identifiable as such.

This document describes methods and systems for creating and using a security mark that addresses at least some of the problems described above, and/or other problems.

### SUMMARY

A secure document includes a substrate on which secure content and non-secure content are printed. The secure content includes a security mark that is made of a background that exhibits a first color, and a foreground that exhibits a second color, all within a bordered area. The first color and the second color together exhibit a chrominance variation that is not visible to the unaided human eye or when viewed with the assistance of a magnifying glass, but that is visible when viewed with the assistance of a microscope.

In some embodiments, the first color and the second color each exhibit a substantially identical luminance, or the first color and second color may exhibit a luminance difference that is at least a factor of ten less than the chrominance variation. For example, one of the colors may be pure black, while the other color may be a mixture of black with cyan, magenta or yellow.

In some embodiments, the foreground comprises microtext having a spatial frequency corresponding to a maximum of 300 line pairs per inch, or the foreground may have a maximum font size of 1 point font.

This patent filing also discloses a system for printing a secure document such as that described above, where the system includes a processor and a printing device. The system also includes a computer-readable medium containing programming instructions that, when executed by the processor, cause the processor to: (i) identify secure content to print on a substrate within a security mark; (ii) identify a first color and a size or spatial frequency for the secure content; and (iii) identify a second color for a background of the security mark. The background will correspond to portions of the security mark where the secure content will not be printed, and the first color and the second color will together exhibit a chrominance variation that is not visible to the unaided human eye or when viewed with the assistance of a magnifying glass, but will be visible when the secure content will be viewed with the assistance of a microscope. The instructions also cause the processor to identify a first set of instructions for printing a document containing the security mark, and form the document by applying the security mark to a substrate so that the security mark includes a background that exhibits the first color, and that exhibits the second color and contains the security mark printed according to the identified size or spatial frequency. The foreground and background will be printed within a bordered area of a security mark.

In some embodiments, the instructions to identify the first color and the second color may include instructions to access a set of available color combinations stored in a memory of the system, and to select the colors from the set. Alternatively, the instructions to identify the first color and the second color may include instructions to: (i) determine a first luminance value and a first chrominance value for a first candidate color; (ii) determine a second luminance value and a second chrominance value for a second candidate color; (iii) compare the luminance values and chrominance values of the candidate colors; and (iv) select the first candidate color as the first color and the second candidate color as the second color only if the first luminance value and the second luminance value are substantially similar while the first chrominance value and the second chrominance value are substantially different, otherwise repeat the luminance and chrominance value determination and comparison steps for an additional pair of candidate colors.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a chart that illustrates human contrast sensitivity for luminance and chrominance.

FIG. 2 illustrates various elements of a system for printing a security mark.

FIG. 3 illustrates an example of a security mark created in accordance with the methods described in this document.

FIG. 4 is a color photograph that illustrates an example of how two variations of the security mark of FIG. 3 may be viewed through a microscope.

FIG. 5 is a block diagram showing various equipment that may be used to implement various embodiments of the processes described in this document; FIG. 6 is a flow diagram that illustrates an example of a process of printing a document containing secure content and non-secure content.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms of any word, and defining adjectives such as “a,” “an” and “the,” each include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

The term “security mark” refers to a marking made on a document that can be used to verify the authenticity of the document, and thus help prevent counterfeiting or unauthorized duplication of the document. Examples of such marks include those known as (i) MicroText marks (i.e., text or other graphics printed at smaller than 1 point size, readable only with a loupe or other magnifying glass); (ii) correlation marks (i.e., printed text that is only visible when superimposed by a “key” overlay; (iii) GlossMark® (a registered trademark of Xerox Corporation) printed characters (i.e., characters printed in a manner such that that is not visible in straight-on view, but becomes visible under inclined illumination); (iv) FluorescentMark characters (i.e., printed characters that are only visible under ultraviolet/black-light; and (v) infrared characters (i.e., printed characters that are only visible in the dark, with an infrared camera).

A “computing device” or “electronic device” is a device that includes a processor and non-transitory computer-readable memory. The memory contains programming instructions in the form of a software application that, when executed by the processor, causes the device to perform various operations according to the programming instructions. Examples of electronic devices include computers, servers, smartphones, personal digital assistants, cameras, tablet devices, electronic readers, personal computers, media players, satellite navigation devices and the like.

The terms “memory” and “computer-readable medium” each refer to a non-transitory device on which computer-readable data, programming instructions or both are stored. Unless the context specifically states that a single device is required or that multiple devices are required, the terms “memory” and “computer-readable medium” include both the singular and plural embodiments, as well as portions of such devices such as memory sectors.

A “microscope” is an optical instrument having a lens or combination of lenses that can be used to magnify and view objects that are too small to be seen in detail by the unaided eye. A microscope will magnify the object to a greater degree than a standard loupe or magnifying glass. For example, the lens of a loupe may cause up to 8×, up to 10× or even up to 12× magnification. A microscope will typically cause 20× or greater magnification. In some embodiments, a microscope may cause 40× or greater magnification. Other magnification levels are possible.

A “print device” is an electronic device that is capable of receiving commands and/or data, and in response printing characters and/or images on a substrate. Printing devices may include, but are not limited to, network printers, production printers, copiers and other devices using ink or toner, and scanners. A print device may also perform a combination of functions such as printing and scanning, in which case such a device may be considered a multifunction device.

A “processor” is a component of an electronic device that executes programming instructions. The term “processor” may refer to either a single processor or to multiple processors that together implement various steps of a process. Unless the context specifically states that a single processor is required or that multiple processors are required, the term “processor” includes both the singular and plural embodiments.

This document describes a security technology that provides a mark that can be decoded with simple tools such as a microscope, but which is not easily identified as a security element by a human user who uses an ordinary loupe or the unaided eye. The technology takes advantage of a characteristic of the human eye that is often overlooked: that a person's sensitivity to luminance (i.e., a measure of the difference between dark and light) is very different from the person's sensitivity to chrominance (a measure of color differentiation, e.g., color1/color2). Therefore, the human eye's sensitivity to luminance can be considered to be a function of spatial frequency—i.e., the characteristics of an object that it is viewing that are periodic across space.

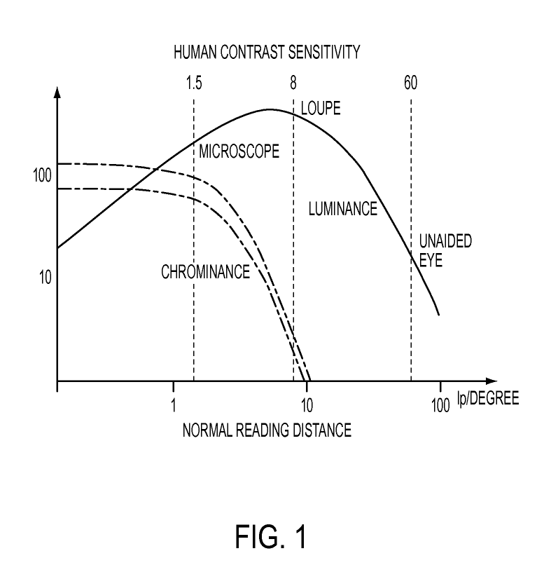

This is illustrated in FIG. 1, where the contrast sensitivity function is shown in an approximate manner. The data results from a mark printed at a 600 dpi print resolution, and thus has a 300 line-pair (cycles) per inch dataset. In FIG. 1, the x-axis represents frequency in the printed mark (measured in line pairs/degree), and the y-axis represents sensitivity. The vertical dotted lines illustrate the results of viewing the mark with the unaided eye (at roughly a 60 cycles/degree spatial frequency), a loupe (roughly 8 cycles/degree), and a 40× microscope (roughly 1.5 cycles/degree). When viewed with the unaided eye at an ordinary reading distance (e.g., approximately 12 to 14 inches from the content), the corresponding viewing angle is tan⁻¹ ( 1/12), tan⁻¹ ( 1/14) and thus between 4.7° and 4.1°. Thus, in this example, 300 cycles per inch will translate to approximately 60 to 70 cycles per degree. The loupe magnifies the angle and thus translates to roughly 7.5 to 8.5 cycles per degree. A 40× microscope provides additional magnification and translates to roughly 1.5 to 1.7 cycles per degree.

In the example of FIG. 1, the dotted line for the unaided eye shows that no chrominance (color differentiation) is visible to the unaided human eye, and the human will detect luminance in the mark only if it exhibits an extremely high contrast. Essentially, this shows that the human eye can detect black microtext printed on a white background (or vice versa), but not much else. When a loupe is used, the spatial frequency changes by roughly a factor of 8, and the luminance is now in a region where the human eye has quasi-optimal sensitivity. In other words, the human can more easily see black/white variations when the human uses a loupe. FIG. 1 also shows that the unaided human eye cannot see any chrominance detail in the mark. With a loupe, the human eye can see little if any chrominance detail. However, the dotted line marked “1.5” illustrates that with a microscope, the human eye is able to detect both color differentiation (chrominance) and luminance. Here, the terms “unaided human eye” or “human eye” refer to a human who exhibits normal or near-normal visual acuity.

Thus, the methods and systems described in this document create a security mark with a low luminance variation—one that that is sufficiently small that it cannot be visible to either the unaided or the loupe-assisted human eye—but with a chrominance variation that can be detected by a microscope.

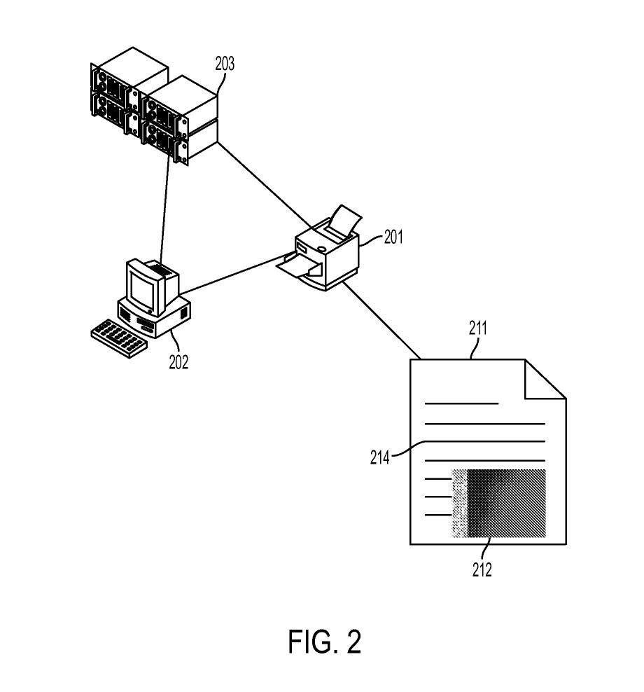

FIG. 2 illustrates the basic elements of a system that may be used to print a security mark. The system includes a print device 201 that includes supply chambers for ink or toner of multiple colors (e.g., CMYK) and a print head that can apply the ink or toner to a substrate to create a multi-colored marking. The print device 201 may include a processor and memory with programming instructions that cause the printer to receive data from an external source and process the data perform various print-related functions. (Such instructions may be known to those of skill in the art as a “digital front end”.) In addition or alternatively, the print device 201 may be in wired or wireless electronic communication with one or more computing devices 202 that include a processor and computer-readable medium with an installed print driver that provides instructions, data or both to the printer. In addition or alternatively, the print device 201 and/or computing device may be in wired or wireless electronic communication with one or more remote servers 203 that include a processor and computer-readable medium that is configured to send instructions, data or both to the printer or the computing device.

In operation, the printer 201 will print a document 211 that contains characters, images or other content items 214 that are visible and thus not secure, along with a security mark 212 containing secure content and created in accordance with the methods described below. The security mark 212 shown in FIG. 2 is merely an example, and it will be described in more detail below.

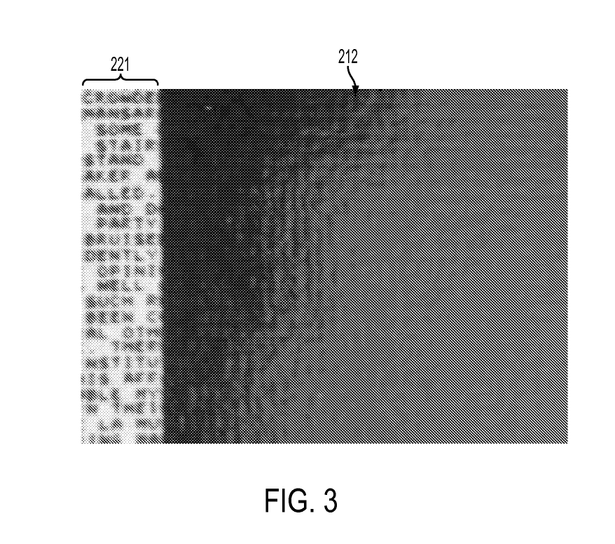

FIG. 3 illustrates the security mark 212 of FIG. 2, along with an illustration of a portion 221 of the mark in which the microtext is visible. In FIG. 3, the boundaries of the security mark 212 form a border within which a background and a foreground are printed. The background exhibits a first color, and the foreground exhibits a second color. The first color (background) and the second color (foreground) together exhibit a chrominance variation that is not visible to the unaided human eye or when viewed with the assistance of a magnifying glass, but that is visible when viewed with the assistance of a microscope.

The first color (background) and the second color (foreground) also exhibit a luminance variation that is not visible to the to the unaided human eye. The luminance variation may or may not be visible when viewed with the assistance of a magnifying glass. In some embodiments, the two colors may exhibit no (or substantially no) luminance difference, resulting in a color difference that is almost purely chrominance. Thus, the two colors have a chrominance variation but a negligible luminance variation.

The foreground and background will thus be printed with ink or toner that are similar in color. For example, one of these elements may be solid black, while the other may be a mixture of solid black (K) with one or more of the other CMY colors. In some embodiments, for example, the second color will have a luminance component that matches some of the black. As an example if the first color is 100% K, the second color could be 50 parts K and 70 parts C. Thus, the two colors will exhibit substantially the same luminance but different chrominance. In various embodiments, this means that the luminance difference between the two colors will be at least a factor of ten less than the chrominance difference between the two colors. Examples of the second color (i.e., the one used with the black (K) may be include: (i) 2 parts solid K, 1 part of each of the other three inks (CMY); (ii) 10 parts solid black (K), 7 parts cyan (C), 3.5 parts magenta (M), and 4 parts yellow (Y); and (ii) 10 parts K, 3.5 parts C, 6 parts M, and 6 parts Y.

In some embodiments, the foreground may include or substantially consist of microtext having a maximum size threshold under 1 point. An example is 0.84 point font. Additional fonts ranging from 0.72 point font to 1.08 point font may be used, along with other sizes. Optionally, the size may be something less than a 1 point font, considering that a readable character could be described by as few as 3 line pairs in many instances where the text is in the English letters and numbers. (Other systems such as Chinese or Japanese may have larger minimum sizes.) Alternatively, the microtext may have a size corresponding to a maximum of 600 line pairs per degree.

The visible portion 221 will not normally be printed on a secure document, but is shown in FIG. 3 for purposes of illustration. In particular, the visible portion shows what the foreground (text) and background (solid white) may look like under a loupe.

A document for printing a secure document may be created by a system such as that shown in FIG. 1, where the printing device 201 is programmed to print the security mark so that it exhibits chrominance and luminance differences such as those described above.

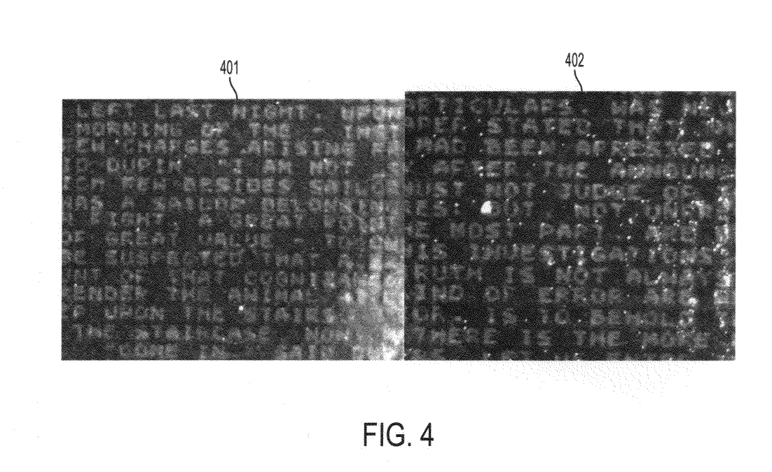

FIG. 4 is an image showing two examples of experimental results of the use of a microscope to magnify the security mark 212 of FIG. 3. In the first example 401, the background is black and the foreground (containing secure microtext) is a mixture of C, Y and K such that the luminance of the background and the luminance of the foreground are substantially identical, but a chrominance difference between the background and foreground is visible through the microscope. The second example 402 yields a similar result with a foreground printed with a mixture of Y, M and K inks.

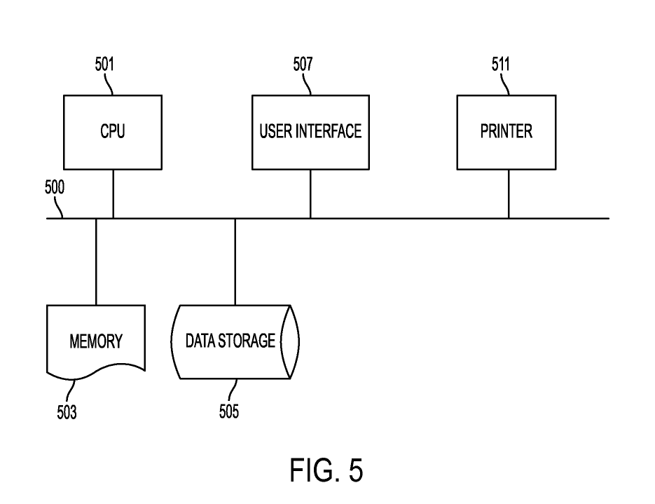

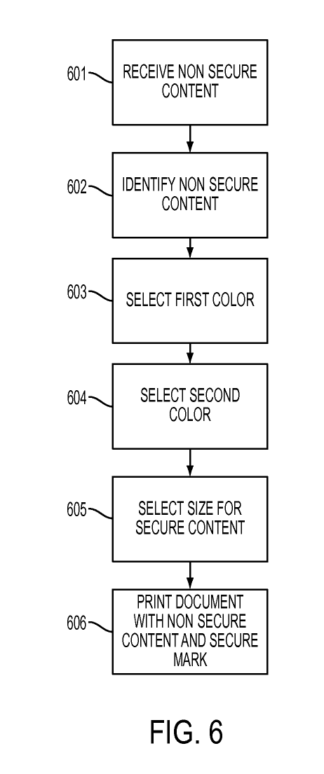

FIG. 5 depicts a block diagram of hardware and/or electronics that may make up a system that modifies the mark elements, develops instructions for printing a combined mark, and prints the combined mark. One or more communications lines 500 such as a bus (for a single device) or network (for multiple devices) may interconnect the illustrated components and allow data and/or signals to flow between the components. CPU 501 represents one or more processors that performs calculations and logic operations required to execute a program. Any number of processors may be available, and they may be part of a single electronic device or distributed across any number of networked electronic devices. When this document and its claims uses the term “processor,” unless specifically stated otherwise it is intended to refer to all such embodiments (i.e., single processor or multiple processors). The processor(s) may access a computer-readable memory device 503 containing programming instructions, along with a data storage facility 505 such as a database that stores the package generation templates and/or rule sets.

A user interface 507 is a device or system that provides output to, and receives input from, a user. The user interface may include a display, audio output, a printer, or another element that provides information to a user. The user interface 507 also may include a touch-sensitive component, microphone, audio port, keyboard, mouse, touch pad, or other input mechanism that is capable of receiving user input. The system also may include one or more printing devices 511, each of which contains hardware that enables it to print marks on a substrate. The printing device(s) will, individually or collectively, will contain toner reservoirs with various toners that are suitable for a security mark, such as CMYK reservoirs. As used in this document, the term “reservoir” means any structure that holds toner, which may be in liquid, solid, gel, or other form.

A system containing elements such as those described above in FIG. 5 may be used to print a document containing secure content and non-secure content. FIG. 6 illustrates an example of a process by which this may performed. The system may include a user interface, such as a keyboard, touch screen, or audio input via which the system may receive non-secure content 601 to be printed on a substrate. Alternative, the system may receive the non-secure content 601 by receiving and opening a data file or other electronic document. The content will formatted to be typically viewable to a person who views or reads the document, and the formatting may occur with any typical or customized document management software, such as word processing software or document publishing software.

The system will select content for a secure mark 602 to print on the substrate along with the non-secure content. The content may include a security code, other unique identifier, or any other set of alphanumeric characters that will serve as the foreground of the secure mark using methods described in this documents. The system may receive the content via the user interface, select it from a set of stored content, randomly generate it, or identify it through any other suitable means.

The system will also select a first color for a background of the secure mark 603 and select a second color for the secure content of the secure mark 604, and select a size 605 for the secure content. The first color and the second color will together exhibit a chrominance variation that is not visible to the unaided human eye or when viewed with the assistance of a magnifying glass. However, when the security mark is printed 606 with content corresponding to the size, the chrominance variation will be visible when viewed with the assistance of a microscope. The selected colors may be selected from a set of available color combinations stored in a memory of the system, or determined in real time based on known or calculated luminance and chrominance values of various available colors and color combinations. For example, the system may determine a first luminance value and a first chrominance value for a first candidate color, determine a second luminance value and a second chrominance value for a second candidate color, and compare the luminance values and chrominance values of the candidate colors. The values may be stored in a memory or received from an external source. The system will use the candidate colors only if their luminance values are substantially similar and chrominance values are substantially different; otherwise the system will repeat the luminance and chrominance value determination and comparison steps for an additional pair of candidate colors.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A secure document, comprising:
a substrate containing secure content and non-secure content imprinted thereon;
wherein the secure content comprises a security mark that comprises:
a background contained within a border, wherein the background exhibits a first color, and
a foreground contained within the border, wherein the foreground exhibits a second color,
wherein the first color and the second color together exhibit a chrominance variation that is not visible to the unaided human eye or when viewed with the assistance of a magnifying glass, but that is visible when viewed with the assistance of a microscope.

2. The secure document of claim 1, wherein the first color and the second color each exhibit a substantially identical luminance.

3. The secure document of claim 1, wherein the first color and the second color exhibit a luminance difference that is at least a factor of ten less than the chrominance variation.

4. The secure document of claim 1, wherein the foreground comprises microtext having a spatial frequency corresponding to a maximum of 300 line pairs per inch.

5. The secure document of claim 1, wherein the foreground has a maximum font size of 1 point font.

6. The secure document of claim 1, wherein one of the first color and the second color is pure black, and the other of the first color and the second color is a mixture of black with cyan, magenta or yellow.

7. A system for printing a secure document, comprising:
a processor;
a printing device;
a computer-readable medium containing programming instructions that, when executed by the processor, cause the processor to:
identify secure content to print on a substrate within a security mark;
identify a first color and a size or spatial frequency for the secure content;
identify a second color for a background of the security mark, wherein the background corresponds to portions of the security mark where the secure content will not be printed, and wherein the first color and the second color will together exhibit a chrominance variation that is not visible to the unaided human eye or when viewed with the assistance of a magnifying glass, but will be visible when the secure content will be viewed with the assistance of a microscope;
identify a first set of instructions for printing a document containing the security mark; and
form the document by applying the security mark to a substrate so that the security mark comprises:
a background contained within a border, wherein the background exhibits the first color, and
a foreground contained within the border, wherein the foreground exhibits the second color and contains the security mark printed according to the identified size or spatial frequency.

8. The system of claim 7, wherein the first color and the second color together also exhibit a substantially identical luminance.

9. The system of claim 7, wherein the first color and the second color each exhibit a luminance variation that is not visible to the unaided human eye or when viewed with the assistance of a magnifying glass, but that is visible when viewed with the assistance of a microscope.

10. The system of claim 7, wherein the first color and the second color exhibit a luminance difference that is at least a factor of ten less than the chrominance variation.

11. The system of claim 7, wherein the secure content comprises microtext and the identified size or spatial frequency is a spatial frequency corresponding to a maximum of 300 line pairs per inch.

12. The system of claim 7, wherein the secure content comprises microtext and the identified size or spatial frequency is a size corresponding to a maximum of 1 point font.

13. The system of claim 7, wherein one of the first color and the second color is pure black, and the other of the first color and the second color is a mixture of black with cyan, magenta or yellow.

14. The system of claim 7, wherein the instructions to identify the first color and the second color comprise instructions to:
access a set of available color combinations stored in a memory of the system; and
select the colors from the set.

15. The system of claim 7, wherein the instructions to identify the first color and the second color comprise instructions to:
determine a first luminance value and a first chrominance value for a first candidate color;
determine a second luminance value and a second chrominance value for a second candidate color;
compare the luminance values and chrominance values of the candidate colors;
select the first candidate color as the first color and the second candidate color as the second color only if the first luminance value and the second luminance value are substantially similar while the first chrominance value and the second chrominance value are substantially different, otherwise repeat the luminance and chrominance value determination and comparison steps for an additional pair of candidate colors.

16. A system for printing a secure document, comprising:
a processor;
a printing device;
a computer-readable medium containing programming instructions that, when executed by the processor, cause the processor to:
identify microtext to print on a substrate within a security mark;
identify a first color and a size or spatial frequency for the microtext;
identify a second color for a background of the security mark, wherein:
the background corresponds to portions of the security mark where the microtext will not be printed,
the first color and the second color will together exhibit a chrominance variation that is not visible to the unaided human eye or when viewed with the assistance of a magnifying glass, but will be visible when the microtext will be viewed with the assistance of a microscope, and
the first color and the second color exhibit a luminance variation that is at least a factor of ten less than the chrominance variation and not visible to the unaided human eye or when viewed with the assistance of a magnifying glass, but that is visible when viewed with the assistance of a microscope;
identify a first set of instructions for printing a document containing the security mark; and
form the document by applying the security mark to a substrate so that the security mark comprises:
a background contained within a border, wherein the background exhibits the first color, and
a foreground contained within the border, wherein the foreground exhibits the second color and contains the security mark printed according to the identified size or spatial frequency.

17. The system of claim 16, wherein the identified size or spatial frequency is a spatial frequency corresponding to a maximum of 300 line pairs per inch.

18. The system of claim 16, wherein the identified size or spatial frequency is a size corresponding to a maximum of 1 point font.

19. The system of claim 16, wherein the instructions to identify the first color and the second color comprise instructions to:
access a set of available color combinations stored in a memory of the system; and
select the colors from the set.

20. The system of claim 16, wherein the instructions to identify the first color and the second color comprise instructions to:
determine a first luminance value and a first chrominance value for a first candidate color;
determine a second luminance value and a second chrominance value for a second candidate color;
compare the luminance values and chrominance values of the candidate colors; and
select the first candidate color as the first color and the second candidate color as the second color only if the first luminance value and the second luminance value are substantially similar while the first chrominance value and the second chrominance value are substantially different, otherwise repeat the luminance and chrominance value determination and comparison steps for an additional pair of candidate colors.
